(19) United States
(12) Patent Application Publication
(10) Pub. No.: US 2018/0144048 A1
(43) Pub. Date: May 24, 2018

(54) APPARATUS AND METHOD FOR MATCHING MULTIPLECOLUMN KEYWORD PATTERNS

(71) Applicant: Somansa Co., Ltd., Seoul (KR)

(72) Inventors: Tae Wan KIM, Seoul (KR); Seung Tae PAEK, Seoul (KR); II Hoon CHOI, Seoul (KR)

(21) Appl. No.: 15/361,922

(22) Filed: Nov. 28, 2016

(30) Foreign Application Priority Data
Nov. 22, 2016 (KR) 10-2016-0155947

(51) Int. Cl. G06F 17/30

(52) U.S. Cl. CPC G06F 17/30696; G06F 17/30684

(57) ABSTRACT

Disclosed is a multiple column keyword pattern matching apparatus configured to match multiple column keyword patterns including a plurality rows and a plurality of columns with respect to a given text. The apparatus includes a multiple keyword matching portion configured to search for keywords included in the multiple column keyword pattern while scanning the given text and generate a keyword matching result including text position information in the given text of a found keyword as a keyword matching result corresponding to the found keyword, a matching result window updating portion configured to add the generated keyword matching result to a matching result window defined with a certain range, and a matching state table updating portion configured to update a matching state table which maintains matching numbers of keyword matching results included in the matching result window.

### CROSS-REFERENCE TO RELATED APPLICATION

This application claims priority to and the benefit of Korean Patent Application No. 2016-0155947, filed on Nov. 22, 2016, the disclosure of which is incorporated herein by reference in its entirety.

### FIELD

The present disclosure relates to an apparatus and a method for matching keyword patterns, and more particularly, to an apparatus and a method for matching multiple column keyword patterns in a document file including texts for protecting personal information of preventing information spill.

### BACKGROUND

To protect personal information or prevent information spill, a text is extracted from a document stored in a disc or an email or transmitted to a network, a universal serial bus (USB), or a printer and is inspected to check whether the document includes important information such as personal information, confidential information, or the like using a method of matching several documents such as keyword pattern matching, regular expression type pattern matching, document similarity measurement and the like.

The keyword pattern matching is a method including registering an important keyword pattern set corresponding to personal information or confidential information in advance and checking whether a certain number or more of keyword patterns are matched by detecting the keyword pattern set from a stored or transmitted document and generally uses a multiple keyword pattern matching method such as Aho-Corasick, Rabin-Karp algorithm and the like.

### SUMMARY

To detect a text with respect to a keyword pattern set in the form of a table including several columns and rows such as (a resident registration number, a phone number, a name) and the like, it is necessary to detect a row ID with a keyword pattern matched with at or above certain number of columns within a certain adjacent range of the text from a full set of (a row ID, a column ID, a text position) that is a matching result generated by detecting using a general multiple keyword pattern matching method. For this, since it is necessary to group the matching result based on the row ID, realign the grouped matching result based on the text position, and sequentially detect a row ID with a keyword pattern matched with at or above a certain number of columns within the certain adjacent range, calculation time and costs are greatly increased in the case of a large amount of keyword pattern group.

Accordingly, an aspect of the present invention provides an apparatus and a method for matching multiple column keyword patterns capable of efficiently detecting a row with a keyword pattern matched with at or above a certain number of columns within a certain adjacent range of a given text with respect to a keyword pattern set in the form of a table including several columns and rows.

In accordance with one aspect of the present invention, a multiple column keyword pattern matching apparatus configured to match multiple column keyword patterns including a plurality rows and a plurality of columns with respect to a given text includes a multiple keyword matching portion configured to search for keywords included in the multiple column keyword pattern while scanning the given text and generate a keyword matching result including text position information in the given text of a found keyword as a keyword matching result corresponding to the found keyword, a matching result window updating portion configured to add the generated keyword matching result to a matching result window defined with a certain range and remove an existing keyword matching result from the matching result window when a difference between a text position of the existing keyword matching result included in the matching result window and a text position of the generated keyword matching result exceeds the certain range, and a matching state table updating portion configured to update a matching number of the added keyword matching result and a matching number of the removed keyword matching result with respect to a matching state table which maintains matching numbers of keyword matching results included in the matching result window.

The multiple column keyword pattern may include a row ID of each of the plurality of rows and a column ID of each of the plurality of columns, and the keyword matching result may include a row ID and a column ID of the found keyword and the text position information.

The matching state table may maintain the matching number with respect to each row ID and column ID of the multiple column keyword pattern.

The apparatus may further include a keyword pattern matching determining portion configured to determine a keyword pattern of a row ID of the keyword matching result added to the matching result window to be matched when the number of columns with a matching number greater than 0 is a certain number or more with respect to the corresponding row ID in the matching state table.

The matching state table updating portion may increase a matching number of the keyword matching result added to the matching result window by 1 and reduce a matching number of the keyword matching result removed from the matching result window by 1.

In accordance with another aspect of the present invention, a multiple column keyword pattern matching method for matching multiple column keyword patterns including a plurality rows and a plurality of columns with respect to a given text includes searching for keywords included in the multiple column keyword pattern while scanning the given text and generating a keyword matching result including text position information in the given text of a found keyword as a keyword matching result corresponding to the found keyword, adding the generated keyword matching result to a matching result window defined with a certain range and removing an existing keyword matching result from the matching result window when a difference between a text position of the existing keyword matching result included in the matching result window and a text position of the generated keyword matching result exceeds the certain range, and updating a matching number of the added keyword matching result and a matching number of the removed keyword matching result with respect to a matching state table which maintains matching numbers of keyword matching results included in the matching result window.

The multiple column keyword pattern may include a row ID of each of the plurality of rows and a column ID of each of the plurality of columns, and the keyword matching result may include a row ID and a column ID of the found keyword and the text position information.

The matching state table may maintain a matching number of each row ID of the multiple column keyword pattern with respect to column ID.

The method may further include determining a keyword pattern of a row ID of the keyword matching result added to the matching result window to be matched when the number of columns with a matching number greater than 0 is a certain number or more with respect to the corresponding row ID in the matching state table.

The updating of the matching numbers may include increasing a matching number of the keyword matching result added to the matching result window by 1 and reducing a matching number of the keyword matching result removed from the matching result window by 1.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates a configuration of a multiple column keyword pattern matching apparatus according to one embodiment of the present invention;

FIG. 2 illustrates an example of a multiple column keyword pattern;

FIG. 3 illustrates an example of a text that is searched for a keyword pattern;

FIG. 4 illustrates a result of aligning keywords included in the multiple column keyword pattern based on a row ID and a column ID;

FIG. 5 illustrates an example of a matching state table that is an initial state matching state table;

FIGS. 6A, 6B, 6C, 6D, 6E and 6F illustrate a keyword matching result generated scanning a text stream of FIG. 3, a matching result window according to each keyword matching result, and an update result of a matching state table;

FIGS. 7A, 7B, 7C, 7D, 7E and 7F are views illustrating the matching state tables of FIGS. 6A, 6B, 6C, 6D, 6E and 6F as tables; and

FIGS. 8A and 8B are flowcharts illustrating a multiple column keyword pattern matching method according to one embodiment of the present invention.

### DETAILED DESCRIPTION

Hereinafter, exemplary embodiments of the present invention will be described in detail with reference to the drawings. In the following description and attached drawings, substantially identical components will be referred to as identical reference numerals and a repeated description thereof will be omitted. Also, in the description of the embodiments of the present invention, detailed explanations of well-known functions and components of the related art will be omitted when it is deemed that they may unnecessarily obscure the essence of the present invention.

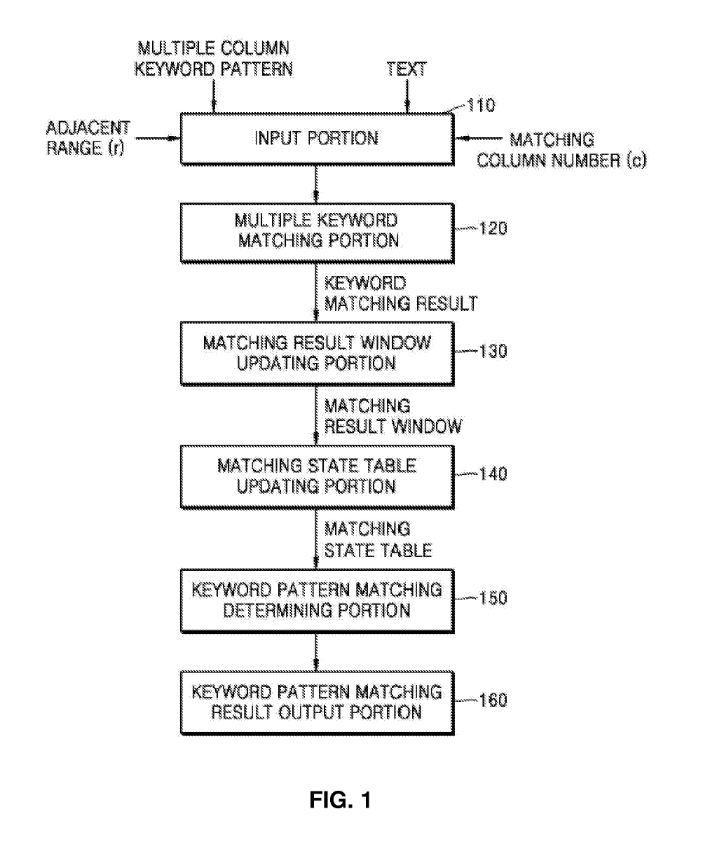

FIG. 1 illustrates a configuration of a multiple column keyword pattern matching apparatus according to one embodiment of the present invention.

Referring to FIG. 1, the multiple column keyword pattern matching apparatus according to the embodiment includes an input portion 110, a multiple keyword matching portion 120, a matching result window updating portion 130, a matching state table updating portion 140, a keyword pattern matching determining portion 150, and a keyword pattern matching result outputting portion 160.

The input portion 110 receives a multiple column keyword pattern that is a keyword pattern set in the form a table including several columns and rows and a text of a document that is searched for a keyword pattern therein. Also, the input portion 110 may receive an adjacent range r that is a reference for determining whether detected keywords are mutually adjacent and the number of columns that is a reference for determining whether a keyword pattern is matched (hereinafter, referred to as a matching column number c). Here, the adjacent range r and the matching column number c may be set to be particular values as default instead of being input and the matching column number c may be set to be the number of total columns of a multiple column keyword pattern or may be set to be a smaller value than the number of total columns.

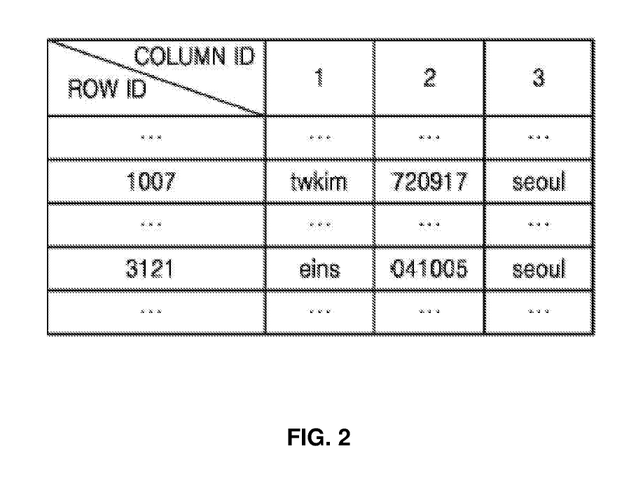

FIG. 2 illustrates an example of the multiple column keyword pattern. As shown in FIG. 2, the multiple column keyword pattern includes a plurality of rows and a plurality of columns (three columns in the drawing) in which a keyword corresponding to each combination of a row and a column is present and a row ID is assigned to each row and a column ID is assigned to each column.

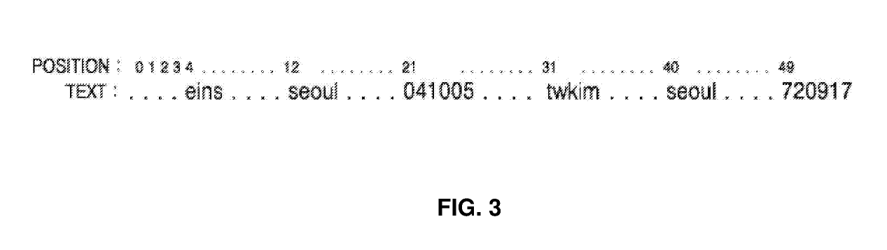

FIG. 3 illustrates an example of a text that is searched for a keyword pattern. A text may have a text stream form as shown in the drawing, and a text position may be assigned to each letter of a text stream.

Hereinafter, in the embodiment of the present invention, for convenience, it will be described as an example that the text of FIG. 3 is searched for the multiple column keyword pattern therein, the adjacent range r is 30, and the matching column number c is 3. In other words, when three or more keyword patterns are matched within a range of 30 letters in the text of FIG. 3 with respect to a certain row of the multiple column keyword pattern of FIG. 2, it is determined that a keyword pattern of the corresponding row is matched.

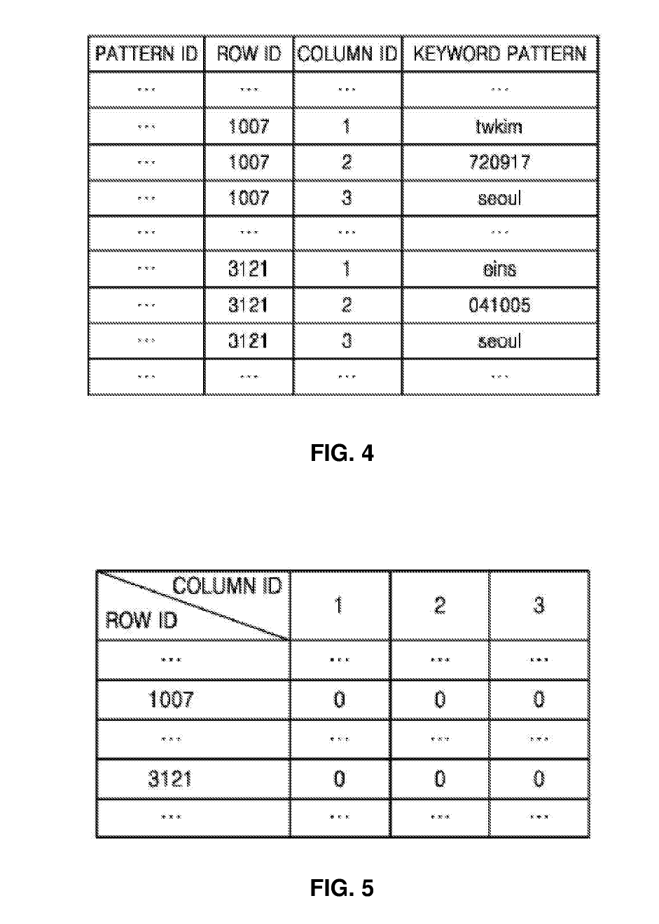

Referring to FIG. 1, the multiple keyword matching portion 120 searches for keywords included in the multiple column keyword pattern while scanning the text and generates a keyword matching result including text position information in a given text of a detected keyword as a keyword matching result corresponding to the detected keyword. Here, well-known multiple keyword pattern matching methods such as Aho-Corasick, Rabin-Karp algorithm may be used for searching for a keyword. Also, for applying the multiple keyword pattern matching method, for example, as shown in FIG. 4, the keywords included in the multiple column keyword pattern of FIG. 2 may be aligned based on row IDs and column IDs and a pattern ID may be assigned for each keyword (that is, each combination of a row ID and a column ID). As the pattern ID, a combination of a row ID and a column ID may be used or a lookup table of row IDs and column IDs may be used.

The multiple keyword matching portion 120 may search for keywords while scanning a given text to an end thereof and may finish searching for keywords before reaching the end of the text when a predetermined finishing condition (for example, when the number of rows with a matched keyword pattern is a certain number or more).

A keyword matching result of the multiple keyword matching portion 120 may include a row ID, a column ID, and text position information of a detected keyword. For example, a newly generated keyword matching result new may have a form as follows.

new=(new.rowid, new.colid, new.pos)

Here, new.rowid, new.colid, and new.pos mean a row ID, a column ID, and a text position of a newly generated keyword matching result, respectively.

For example, referring to FIGS. 3 and 4, (3121, 1, 4) is generated as a keyword matching result when eins at a text position 4 is detected, (3121, 3, 12) and (1007, 3, 12) are generated as a keyword matching result when seoul at a text position 12 is detected, (3121, 2, 21) is generated as a keyword matching result when 041005 at a text position 21 is detected, and (1007, 1, 31) is generated as a keyword matching result when twkim at a text position 31 is detected.

Referring to FIG. 1 again, the matching result window updating portion 130 defines a matching result window in the adjacent range r and adds a keyword matching result newly generated by the multiple keyword matching portion 120 to the matching result window. Also, when a text position of an existing keyword matching result included in a matching result window and a text position of a newly generated keyword matching result exceed the adjacent range r, the matching result window updating portion 130 removes the existing keyword matching result from the matching result window. When the text position of the existing keyword matching result is within the adjacent range r from the newly generated keyword matching result, the existing keyword matching result remains in the matching result window. Accordingly, the matching result window is a set of keyword matching results with a difference between the newly generated keyword matching result and the text position within the adjacent range r.

When an existing matching result window is referred to as Win_old={matched} (here, matched is a keyword matching result included in the existing matching result window and a keyword matching result newly included in the matching result window is referred to as Shift_in={new}, a keyword matching result removed from the matching result window may be referred to as Shift_out={matched∈Win_old|new.pos−matched.pos>r} and an updated matching result window may be referred to as Win_new=(W_old−Shift_out)∪Shift_in.

When the matching result window described above is used, since it is unnecessary to maintain the whole keyword pattern matching result and it is necessary only to maintain a keyword pattern matching result within a certain range, it is efficient.

The matching state table updating portion 140 defines a matching state table that maintains matching numbers of keyword matching results included in the matching result window, updates a matching number of a keyword matching result added to the matching result window at the matching result window updating portion 130, and updates a matching number of a keyword matching result removed from the matching result window.

FIG. 5 illustrates an example of a matching state table. The matching state table maintains a matching number in a matching result window with respect to a keyword of each row ID and column ID of a multiple column keyword pattern. As shown in the drawing, all of the matching numbers are set to be 0 in the matching state table in an initial state.

In detail, the matching state table updating portion 140 increases a matching number of a keyword matching result added to the matching result window by 1 and reduces a matching number of a keyword matching result removed from the matching result window by 1. Through the matching state table, a matching number of a keyword matching result of the matching result window in an up-to-date state may be maintained and the matching number may be accessed using an index of (a row ID, a column ID).

The matching state table may be shown as S{(a row ID, a column ID, a matching number)}, and a process of updating the matching state table may be shown as follows.

S(new.rowid, new.colid)+=1)

∀ matched∈Shift_out, S(matched.rowid, matched.colid)−=1

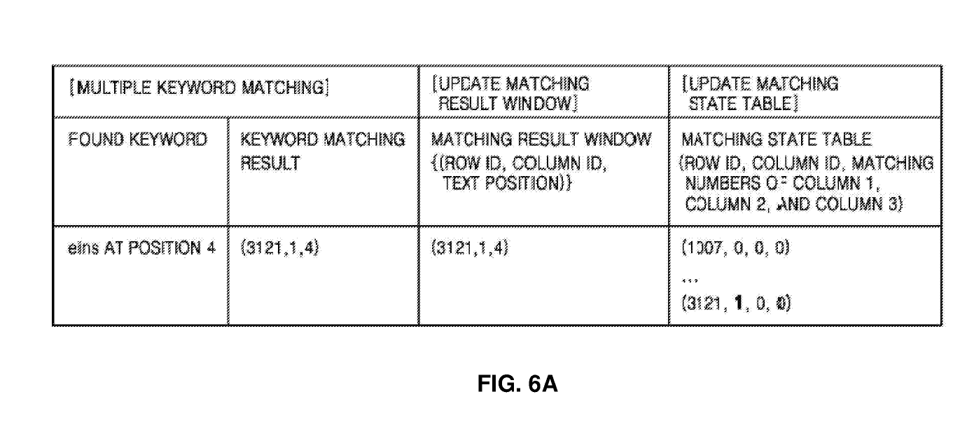

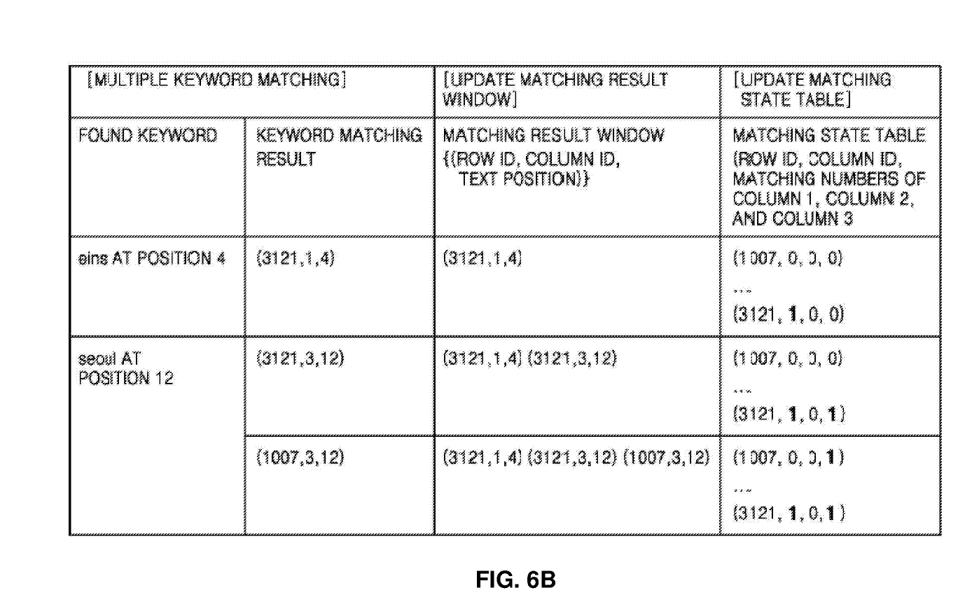

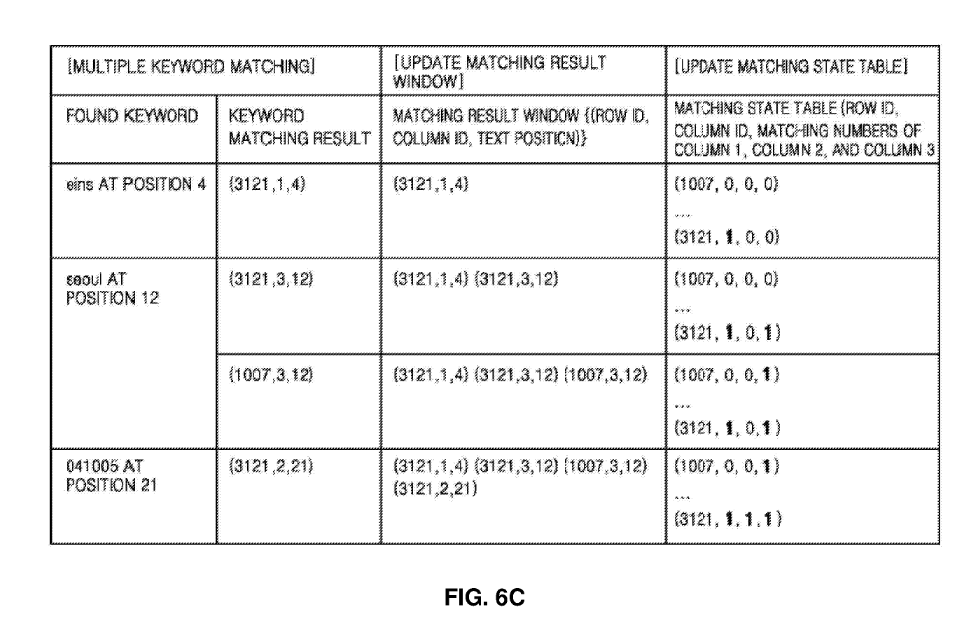

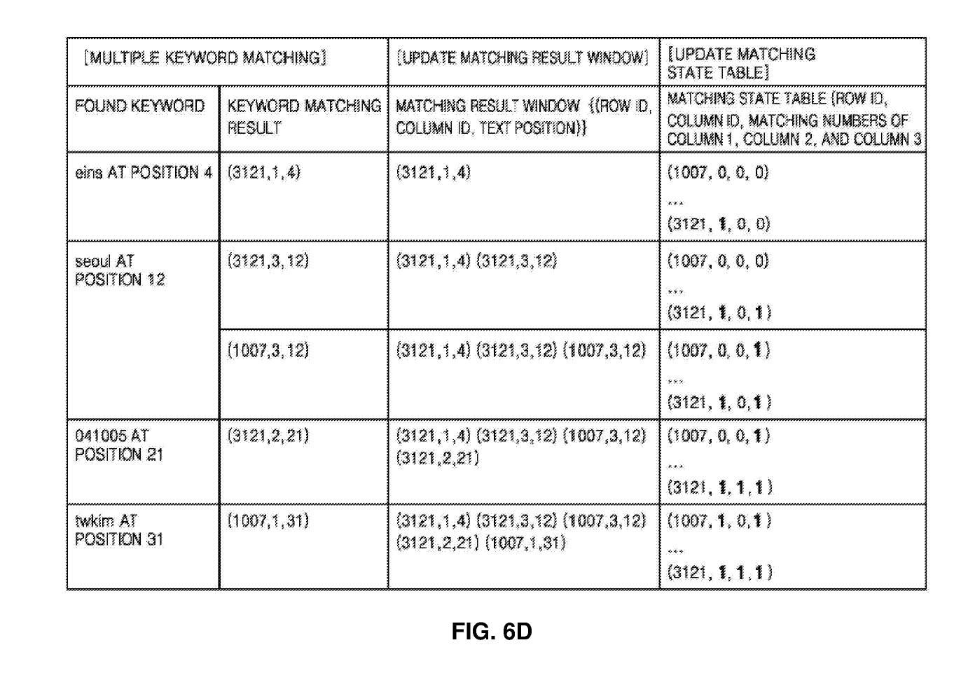

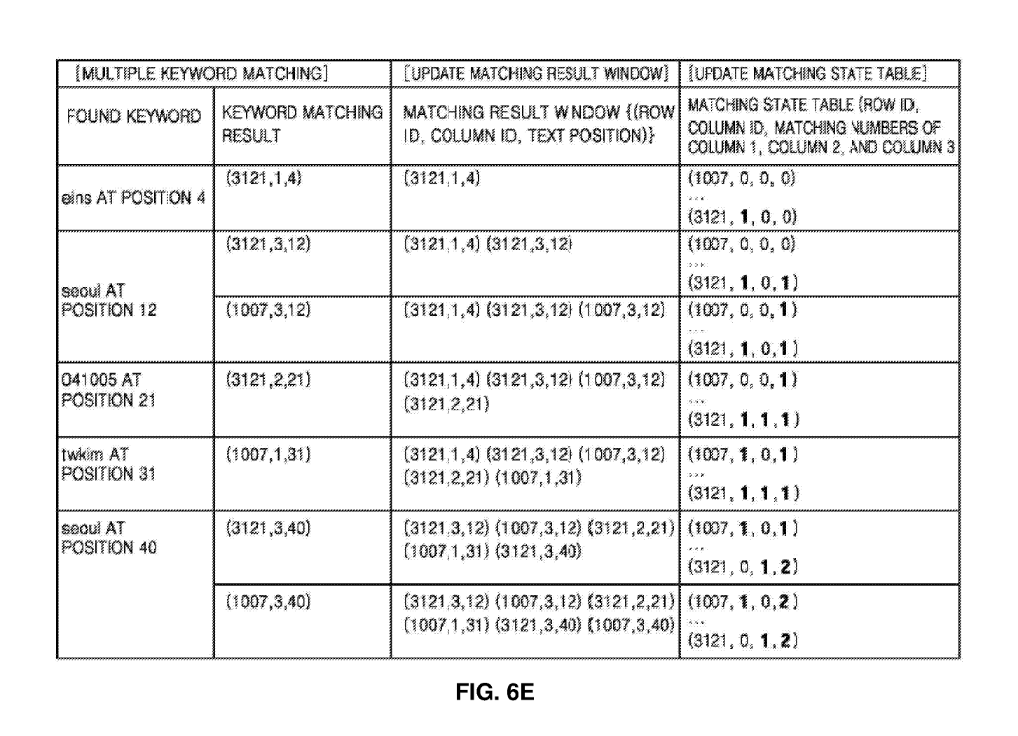

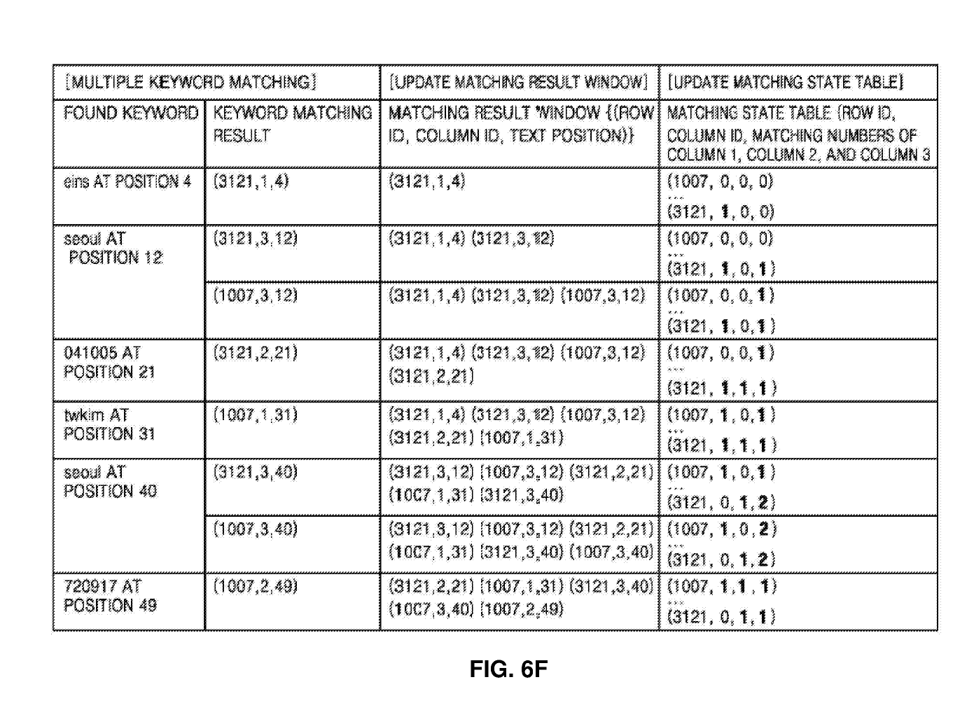

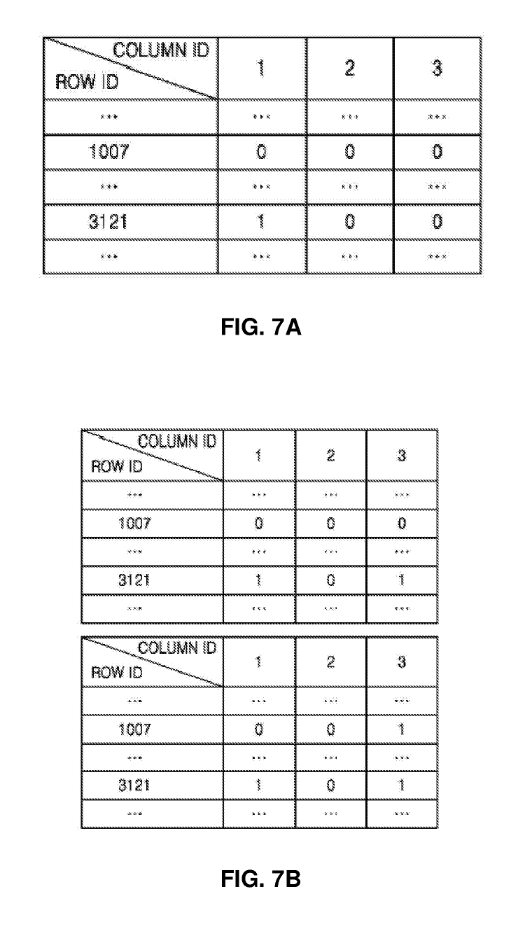

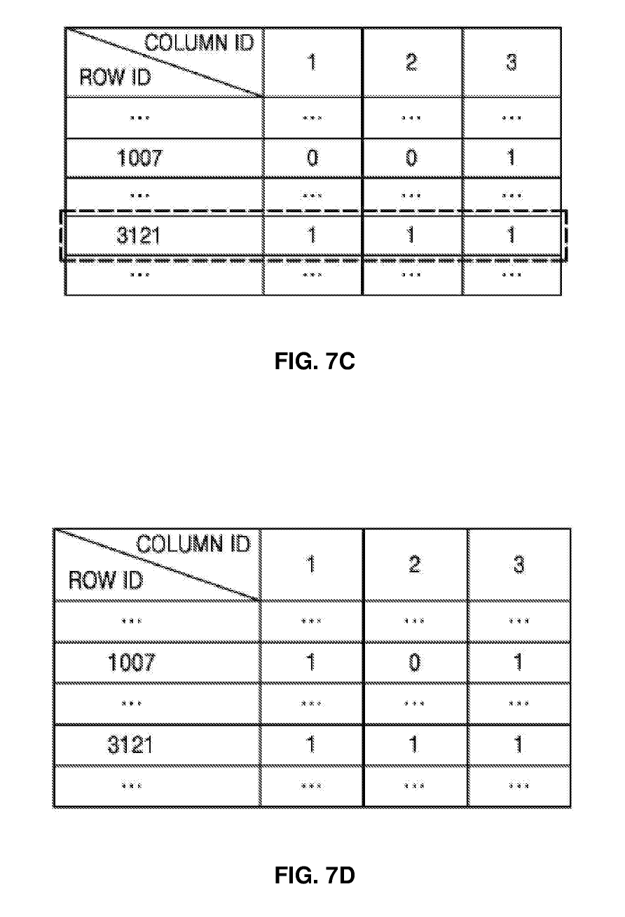

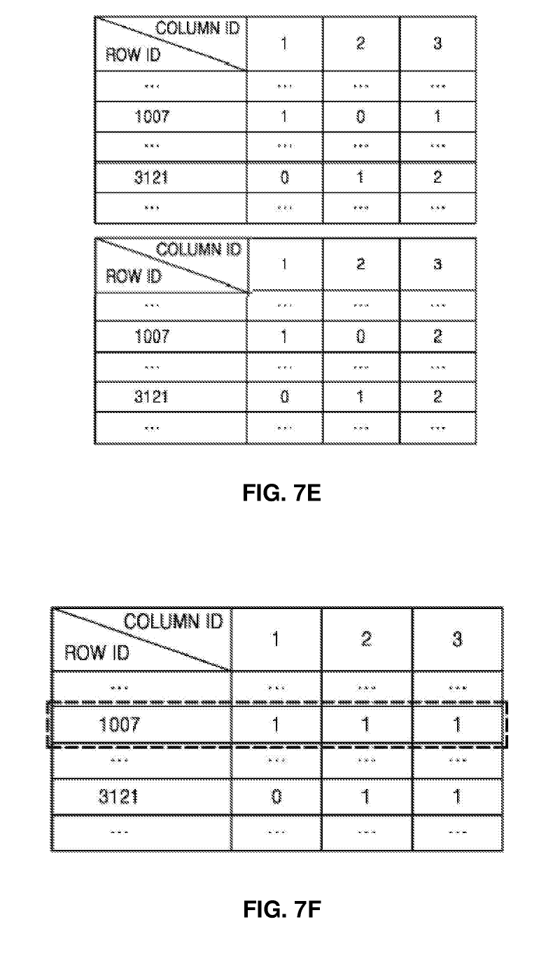

FIGS. 6A to 6F illustrate a keyword matching result generated scanning a text stream of FIG. 3, a matching result window according to each keyword matching result, and an update result of a matching state table. FIGS. 7A to 7F are views illustrating the matching state tables of FIGS. 6A to 6F as tables.

Referring to FIG. 6A, when eins at a text position 4 is detected, (3121, 1, 4) is generated as a keyword matching result and is added to the matching result window. Accordingly, as sown in FIGS. 6A and 7A, a matching number of (a row ID, a column ID)=(3121, 1) in the matching state table comes to 1.

Referring to FIG. 6B, when seoul at a text position 12 is detected, (3121, 3, 12) is generated as a keyword matching result and is added to the matching result window. Accordingly, as sown in FIGS. 6B and 7B, a matching number of (a row ID, a column ID)=(3121, 3) in the matching state table comes to 1. Also, (1007, 3, 12) is generated as a keyword matching result and added to the matching result window, and a matching number of (a row ID, a column ID)=(1007, 3) in the matching state table comes to 1.

Referring to FIG. 6C, when 041005 at a text position 21 is detected, (3121, 2, 21) is generated as a keyword matching result and is added to the matching result window. Accordingly, as shown in FIGS. 6C and 7C, a matching number of (a row ID, a column ID)=(3121, 2) in the matching state table comes to 1.

Referring to FIG. 6D, when twkim at a text position 31 is detected, (1007, 1, 31) is generated as a keyword matching result and is added to the matching result window. Accordingly, as sown in FIGS. 6D and 7D, a matching number of (a row ID, a column ID)=(1007, 1) in the matching state table comes to 1.

Referring to FIG. 6E, when seoul at a text position 40 is detected, (3121, 3, 40) is generated as a keyword matching result and is added to the matching result window. That is, since the text position of the newly generated keyword matching result is 40 and the text position of (3121, 1, 4) among existing keyword matching results is 4, a difference between the text positions 40−4=36 that exceeds 30 that is the adjacent range r. Accordingly, (3121, 1, 4) among existing keyword matching results is removed from the matching result window. As shown in FIGS. 6E and 7E, as (3121, 3, 40) is added to the matching result window, the matching number of (a row ID, a column ID)=(3121, 3) increases by 1 and comes to 2. As (3121, 1, 4) is removed from the matching result window, the matching number of (a row ID, a column ID)=(3121, 1) is reduced by 1 and comes to 0. Also, (1007, 3, 40) is generated as a keyword matching result and added to the matching result window, and the matching number of (a row ID, a column ID)=(1007, 3) in the matching state table is increased by 1 and comes to 2.

Referring to FIG. 6F, when 720917 at a text position 49 is detected, (1007, 2, 49) is generated as a keyword matching result and is added to the matching result window. That is, since the text position of the newly generated keyword matching result is 49 and the text positions of (3121, 3, 12) and (1007, 3, 12) among existing keyword matching results are 12, a difference between the text positions 49−12=37 that exceeds 30 that is the adjacent range r. Accordingly, (3121, 3, 12) and (1007, 3, 12) among existing keyword matching results are removed from the matching result window.

As shown in FIGS. 6F and 7F, as (1007, 2, 49) is added to the matching result window, the matching number of (a row ID, a column ID)=(1007, 2) increases by 1 and comes to 2. As (3121, 3, 12) and (1007, 3, 12) are removed from the matching result window, each of the matching numbers of (a row ID, a column ID)=(3121, 3) and (a row ID, a column ID)=(1007, 3) is reduced by 1 and comes to 1.

Referring to FIG. 1 again, when the number of columns with a matching number at or above 0 with respect to a row ID of a keyword matching result added to a matching result window is at or above the matching column number c, the keyword pattern matching determining portion 150 determines that a keyword pattern of a corresponding row is matched. A process of determining whether a keyword pattern is matched with respect to new.rowid that is a row ID of a keyword matching result added to the matching result window may be shown as follows.

In case of |{colid|S(new.rowid, colid)>0}|>=c, keyword pattern matching of the row ID new.rowid, for example, referring to FIGS. 6C and 7C, since a row ID of (3121, 2, 21) that is a keyword matching result added to the matching result window is 3121, the number of columns with a matching number greater than 0 with respect to the row ID 3121 in a matching state table is 3 and is at or above the matching column number c=3, a keyword pattern of the row ID 3121 is determined to be matched. That is, it may be known that three or more keyword patterns (eins, 0401005, seoul) of the row ID 3121 are matched within the adjacent range r of 30 letters.

Also, referring to FIGS. 6F and 7F, since a row ID of (1007, 2, 49) that is a keyword matching result added to the matching result window is 1007 and the number of columns with a matching number greater than 0 with respect to the row ID 1007 is 3 and is at or above the matching column number c=3, a keyword pattern of the row ID 1007 is determined to be matched. That is, it may be known that three or more keyword patterns (twkim, 720917, seoul) of the row ID 1007 are matched within the adjacent range r of 30 letters.

The keyword pattern matching result outputting portion 160 outputs a keyword pattern matching result checked by the keyword pattern matching determining portion 150. Here, the keyword pattern matching result may include a row ID with a matched keyword pattern, the number of rows with a matched keyword pattern, a keyword combination corresponding to the matched keyword pattern and the like.

Operations of the multiple keyword matching portion 120, the matching result window updating portion 130, the matching state table updating portion 140, the keyword pattern matching determining portion 150, and the keyword pattern matching result outputting portion 160 described above may be performed until reaching an end of a given text or may be finished even before reaching the end of the given text when a certain condition is satisfied, for example, the number of rows with a matched keyword pattern is a certain number or more. In case of the latter, the keyword pattern matching result outputting portion 160 may output checked keyword pattern matching results until a finishing condition is satisfied.

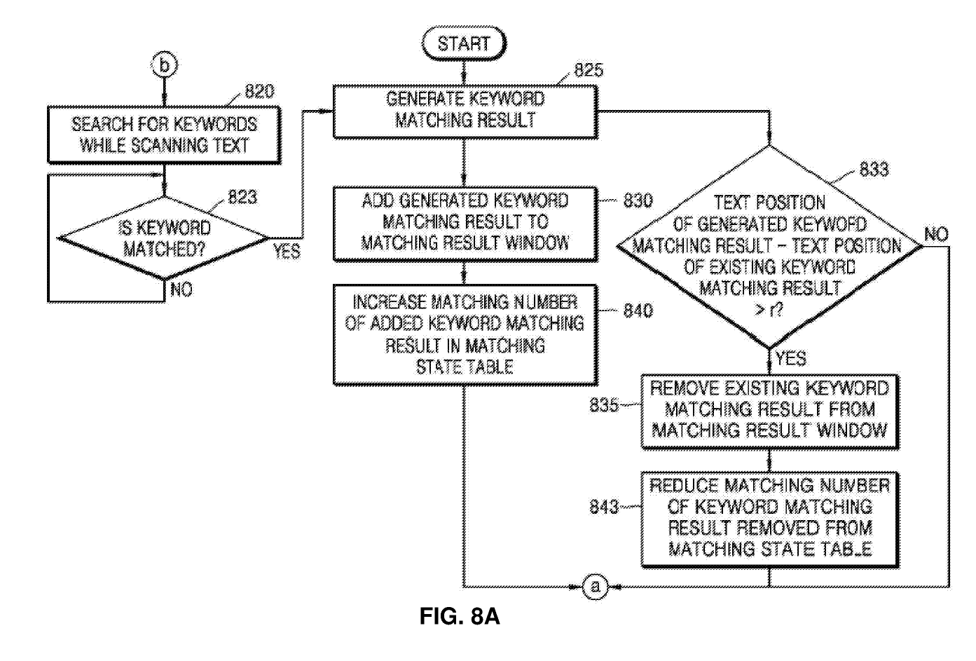

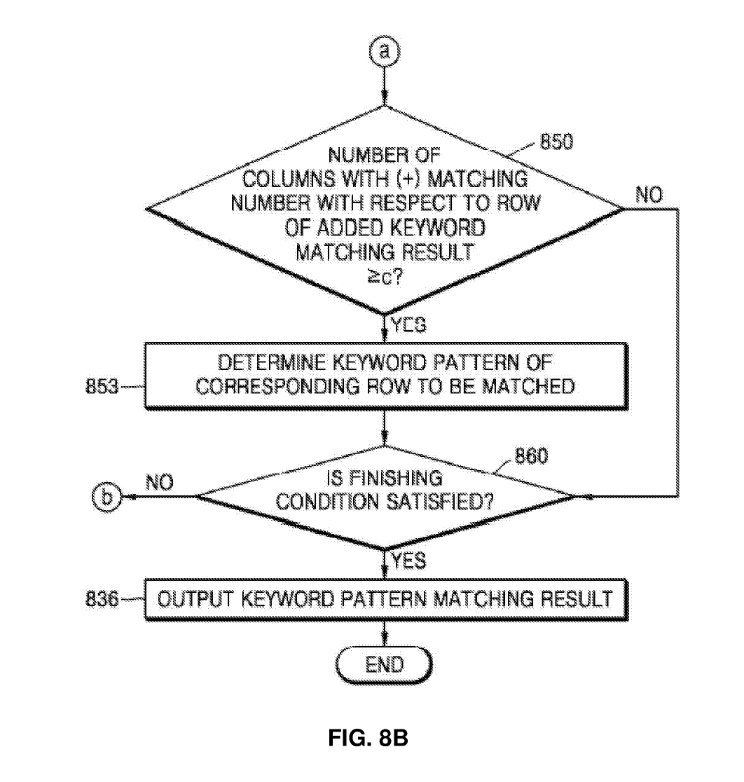

FIGS. 8A and 8B are flowcharts illustrating a multiple column keyword pattern matching method according to one embodiment of the present invention. The multiple column keyword pattern matching method according to the embodiment includes operations performed by the multiple column keyword pattern matching apparatus described above. Accordingly, content described above in relation to the multiple column keyword pattern matching apparatus will be also applied to the multiple column keyword pattern matching method according to the embodiment even when it is omitted below.

In 820, the multiple keyword matching portion 120 searches for keywords included in a multiple column keyword pattern while scanning a given text.

When a keyword is matched in 823, the multiple keyword matching portion 120 generates a keyword matching result including a row ID, a column ID, and text position information of a found keyword in 825.

In 830, the matching result window updating portion 130 adds the keyword matching result generated in 825 to a matching result window.

In 833, the matching result window updating portion 130 checks whether a difference between a text position of the keyword matching result generated in 825 and a text position of an existing keyword matching result included in the matching result window exceeds the adjacent range r and then removes the existing keyword matching result from the matching result window in 835 when the difference exceeds the adjacent range r.

In 840, the matching state table updating portion 140 increases a matching number of the keyword matching result added to the matching result window in a matching state table.

In 843, the matching state table updating portion 140 reduces a matching number of the keyword matching result removed from the matching result window in the matching state table.

The keyword pattern matching determining portion 150 checks whether the number of columns with a matching number greater than 0 with respect to a row ID of the keyword matching result added to the matching result window is at or above the matching column number c in 850 and determines that a keyword pattern of a corresponding row is matched in 853 when the number of columns is at or above the matching column number c.

In 860, when a certain finishing condition (for example, an end of a given text is reached or the number of rows with a matched keyword pattern is a certain number or more) is satisfied, the keyword pattern matching result outputting portion 160 outputs a keyword pattern matching result such as a row ID with a matched keyword pattern, the number of rows with a matched keyword pattern, a keyword combination corresponding to the matched keyword pattern and the like in 836.

An apparatus according to embodiments of the present invention may include a processor, a memory which stores and executes program data, a permanent storage such as a disk drive, a communication port for communication with an external apparatus, a user interface apparatus such as a touch panel, a key, a button and the like. Methods embodied by a software module or an algorithm are codes or program instructions readable by a computer executable by the processor and may be stored in a computer-readable recording medium. Here, the computer-readable recording medium includes a magnetic storage medium (for example, a read-only memory (ROM), a random-access memory (RAM), a floppy disk, a hard disk and the like), an optical reader (for example, a compact disc ROM (CD-ROM), a digital versatile disc (DVD) and the like. The computer-readable recording medium may store and execute computer-readable codes that are distributed to computer systems connected through a network and readable by a computer in a distributed manner. The medium may be readable by a computer, stored in a memory, and executed by a processor.

The embodiments of the present invention may be performed by functional block components and various processing operations. The functional blocks described above may be embodied by various numbers of hardware and/or software components configured to execute particular functions. For example, the embodiment may employ integrated circuit components configured to perform various functions under the control of one or more microprocessors or other controllers such as a memory, processing, logic, a lookup table and the like. Like the case in which the components in the present invention may be executed by software programming or software elements, the embodiments may be embodied as programming or scripting languages such as C, C++, Java, an assembler and the like including various algorithms embodied by a combination of data structures, processors, routines, or other programming components. Functional aspects may be embodied by algorithms executed by one or more processors. Also, the embodiments may employ typical technologies for setting electronic environments, processing signals, and/or processing data and the like. The terms “mechanism”, “element”, and “component” may be generally used and should not be limited to mechanical and physical components. The terms may include meanings of a series of routines of software in connection with a processor and the like.

Particular executions described with respect to the embodiments are merely examples and do not intend to the scope of the embodiments by any methods. For conciseness of specification, descriptions of typical electronic components, control systems, software, and other functional aspects of the systems may be omitted. Also, connections of lines or connecting members among components shown in the drawings are examples of functional connections and/or physical or circuit connections and may be embodied various functional connections, physical connections, or circuit connections that are substitutable or addable in an actual apparatus. Also, unless mentioned in detail such as “essential”, “importantly” and the like, components may be not necessarily needed for applying the present invention.

According to the embodiments of the present invention, a keyword matching result is generated by scanning a given text and a matching result window defined to be a certain range corresponding to an adjacent range and a matching state table for maintaining a matching number of a keyword matching result included in the matching result window are used, thereby efficiently detecting a row with a keyword pattern matched with at or above a certain number of columns within a certain adjacent range of the given text.

The exemplary embodiments of the present invention have been described above. It should be understood by one of ordinary skill in the art that the present invention may be modified without departing from the essential features of the present invention. Therefore, the disclosed embodiments should be considered not in a limitative point of view but in a descriptive point of view. It should be understood that the scope of the present invention is defined by the claims not by the above description and includes all differences within the equivalent scope thereof.

What is claimed is:

1. A multiple column keyword pattern matching apparatus configured to match multiple column keyword patterns including a plurality rows and a plurality of columns with respect to a given text, comprising:
a multiple keyword matching portion configured to search for keywords included in the multiple column keyword pattern while scanning the given text and generate a keyword matching result including text position information in the given text of a found keyword as a keyword matching result corresponding to the found keyword;
a matching result window updating portion configured to add the generated keyword matching result to a matching result window defined with a certain range and remove an existing keyword matching result from the matching result window when a difference between a text position of the existing keyword matching result included in the matching result window and a text position of the generated keyword matching result exceeds the certain range; and
a matching state table updating portion configured to update a matching number of the added keyword matching result and a matching number of the removed keyword matching result with respect to a matching state table which maintains matching numbers of keyword matching results included in the matching result window.

2. The apparatus of claim 1, wherein the multiple column keyword pattern comprises a row ID of each of the plurality of rows and a column ID of each of the plurality of columns, and
wherein the keyword matching result comprises a row ID and a column ID of the found keyword and the text position information.

3. The apparatus of claim 2, wherein the matching state table maintains the matching number with respect to each row ID and column ID of the multiple column keyword pattern.

4. The apparatus of claim 3, further comprising a keyword pattern matching determining portion configured to determine a keyword pattern of a row ID of the keyword matching result added to the matching result window to be matched when the number of columns with a matching number greater than 0 is a certain number or more with respect to the row ID in the matching state table.

5. The apparatus of claim 1, wherein the matching state table updating portion increases a matching number of the keyword matching result added to the matching result window by 1 and reduces a matching number of the keyword matching result removed from the matching result window by 1.

6. A multiple column keyword pattern matching method for matching multiple column keyword patterns including a plurality rows and a plurality of columns with respect to a given text, comprising:
searching for keywords included in the multiple column keyword pattern while scanning the given text and generating a keyword matching result including text position information in the given text of a found keyword as a keyword matching result corresponding to the found keyword;
adding the generated keyword matching result to a matching result window defined with a certain range and removing an existing keyword matching result from the matching result window when a difference between a text position of the existing keyword matching result included in the matching result window and a text position of the generated keyword matching result exceeds the certain range; and
updating a matching number of the added keyword matching result and a matching number of the removed keyword matching result with respect to a matching state table which maintains matching numbers of keyword matching results included in the matching result window.

7. The method of claim 6, wherein the multiple column keyword pattern comprises a row ID of each of the plurality of rows and a column ID of each of the plurality of columns, and
wherein the keyword matching result comprises a row ID and a column ID of the found keyword and the text position information.

8. The method of claim 7, wherein the matching state table maintains a matching number of each row ID of the multiple column keyword pattern with respect to column ID.

9. The method of claim 8, further comprising determining a keyword pattern of a row ID of the keyword matching result added to the matching result window to be matched when the number of columns with a matching number greater than 0 is a certain number or more with respect to the corresponding row ID in the matching state table.

10. The method of claim 6, wherein the updating of the matching numbers comprises increasing a matching number of the keyword matching result added to the matching result window by 1 and reducing a matching number of the keyword matching result removed from the matching result window by 1.
